(19) United States
(12) Patent Application Publication
(10) Pub. No.: US 2005/0050754 A1
(43) Pub. Date: Mar. 10, 2005

(54) Handwear and footwear dryer rack with removable portable heater

(76) Inventor: Jean-Pierre Deblois, St-Anselme (CA)

Correspondence Address: INVENTARIUM, SUITE 1607, 4050 ROSEMONT BLVD, MONTREAL, QC, H1X2M4, CA

(21) Appl. No.: 10/920,072

(22) Filed: Aug. 16, 2004

Related U.S. Application Data
(60) Provisional application No. 60/495,857, filed on Aug. 18, 2003.

(51) Int. Cl. F26B 25/00; F26B 25/06; F26B 19/00

(52) U.S. Cl. 34/218

(57) ABSTRACT

A handwear footwear dryer rack is made up of two side panels, a back panel, a front stopper, a support shelf, and a top panel. The side panels hold between them the top shelf at the top, and a support shelf situated underneath the top shelf. The back panel and the front stopper provide structural integrity to the handwear footwear dryer rack as well as a restrained confinement to a heater positioned atop the support shelf. The front stopper, with the removal of one or two mechanical fastener, can be flipped out so as to provide for a fast egress of the heater without unnecessary additional dismantling.

### BACKGROUND OF THE INVENTION:

1. Field of the Invention

This invention relates generally to dryers for gloves, mittens, boots and socks but more particularly to an assemblable handwear and footwear rack having a heater for drying which can be removed from the rack and used as a supplemental room heater.

2. Background of the Invention

In northern climes where winter activities are a way of life, winter clothes can become damp from the melting snow. Children are particularly adept at getting their clothes, more specifically their mittens, gloves, boots, and even their socks, quite wet. Getting these wears fully dry in time for the next outing can prove difficult at times so a way to make them dry as fast as possible needs to be found.

Usually, users put their damp wears directly on top of baseboard heaters or even on top of central heating furnaces, indeed anything that is hot and can dry wears rapidly. It should come as no surprise then that some inventors came up with contraptions designed to be hooked directly onto baseboard heaters to allow for proper hanging of the wears. Some devices are installed over air duct grilles to benefit from warm forced air.

Many devices use pipes into which hot air is blown. These devices come in various sizes and shapes and, although very useful, they take up some space and because they are very efficient at what they do, are only required for short periods of time but stay there and become an encumberance.

### SUMMARY OF THE INVENTION

The present invention discloses a rack into which is installed a portable heater which blows air through a series of pipes onto which various handwears or footwears are hung. The heater can also be used as a portable supplemental heater when there is no need for drying wears. Also, the rack itself is easily demountable so that it can be stowed away when not in use, in the off season for example.

It is therefore a first object of this invention to provide for a simple to use handwear and footwear dryer rack.

It is a second object of this invention to provide for a dryer rack having a removable portable heater.

It is a third object of this invention to provide for a dryer rack that is can be assembled and disassembled easily and rapidly.

It is a fourth object of this invention to provide for a dryer rack which can be sold with or without a heater.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

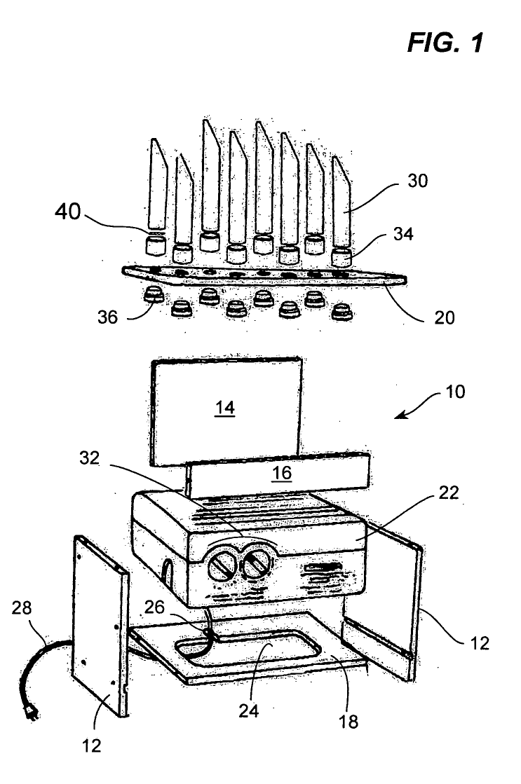

FIG. 1 Exploded perspective view of the rack.

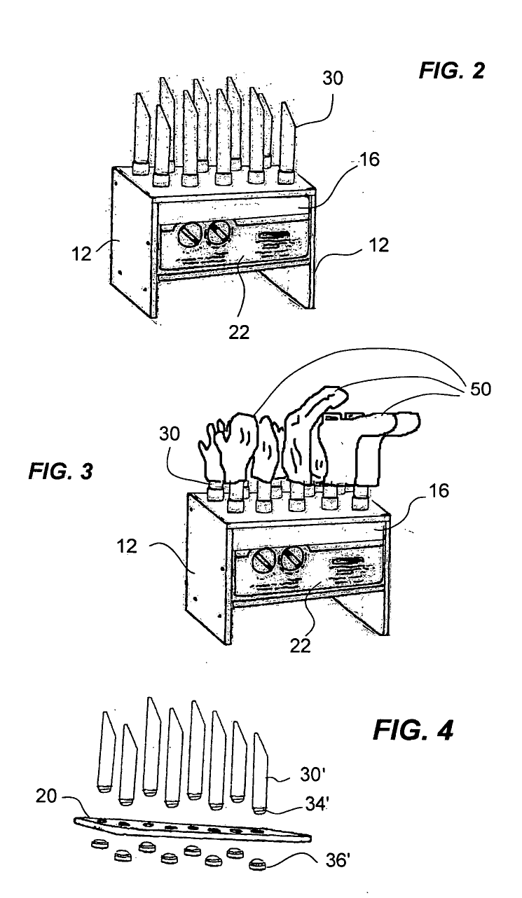

FIG. 2 Perspective view of the rack.

FIG. 3 Perspective view of the rack in use.

FIG. 4 Perspective view of an alternate method of attaching the air pipes.

### DETAILED DESCRIPTION OF THE PREFERRED EMBODIMENT

A handwear footwear dryer rack (10) is made up of two side panels (12), a back panel (14), a front stopper (16), a support shelf (18), and a top panel (20). The side panels (12) hold between them the top shelf (18) at the top, and a support shelf (18) situated underneath the top shelf (18). The back panel (14) and the front stopper (16) provide structural integrity to the handwear footwear dryer rack (10) as well as a restrained confinement to a heater (22) positioned atop the support shelf (18). The front stopper (16), with the removal of one or two mechanical fastener, can be flipped out so as to provide for a fast egress of the heater (22) without unnecessary additional dismantling. The support shelf (18) has a large opening (24) for air and is set at a sufficient clearance from the resting place (generally the floor) of the handwear footwear dryer rack (10) that a large volume of air can circulate unimpeded. The heater (22), which is chosen from a variety of commercially available heaters having some basic characteristics such as when positioned so that it lays on its back, it has its controls (32), which are normally on top, now in front as per FIGS. 2-3. A slit (26) made into the support shelf (18) allows for the passage and restraining of the heater's power cord (28). The top panel carries the air pipes (30) which are configured and sized for receiving footwear and handwear (50). Air enters the heater (22) through the large opening (24) and exits through the air pipes (30). Small screens (40) (only one shown) can be inserted into each air pipe (30) to block dust or similar small particles from entering the footwear or handwear (50).

The air pipes (30) are frictionally and releasably engaged into fittings (34) so that the handwear footwear dryer rack (10) can rapidly be disassembled. The fittings can be integrated as part of the top panel (20) or be affixed to it through various means including, as per FIG. 3, by way of female threaded couplings (36).

Alternatively, FIG. 4 shows an embodiment wherein threaded air pipes (30′) do not have fittings (34) but rather have threads (34′) which threadably engage into threaded nuts (36′). A hybrid embodiment having male threaded couplings (not showns) threadably engaging threaded nuts (36′) could also be used.

1. A handwear footwear dryer rack comprising:
two side panels, a back panel, a front stopper, a support shelf, and a top panel;
said side panels holding between them said top shelf at the top and said support shelf situated underneath said top shelf;
said back panel and said front stopper providing structural integrity as well as a restraining and confining a heater positioned atop said support shelf;
said support shelf having an opening for air;
said top panel receiving air pipes;
said air pipes configured and sized for receiving handwear and footwear.

2. A handwear footwear dryer rack as in claim 1 wherein:
small screens are inserted into each air pipe to block dust or similar small particles.

3. A handwear footwear dryer rack as in claim 1 wherein:
said air pipes being frictionally and releasably engaged into fittings so that the handwear footwear dryer rack can rapidly be disassembled.

4. A handwear footwear dryer rack as in claim 1 wherein:
said fittings being integrated by way of female threaded couplings.

5. A handwear footwear dryer rack as in claim 1 wherein:
threaded airpipes having threads threadably engaging into threaded nuts.

6. A handwear footwear dryer rack as in claim 2 wherein
said air pipes being frictionally and releasably engaged into fittings so that the handwear footwear dryer rack can rapidly be disassembled.

7. A handwear footwear dryer rack as in claim 2 wherein:
said fittings being integrated by way of female threaded couplings.

8. A handwear footwear dryer rack as in claim 2 wherein:
threaded airpipes having threads threadably engaging into threaded nuts.
